(19) United States
(12) Patent Application Publication
(10) Pub. No.: US 2014/0068981 A1
(43) Pub. Date: Mar. 13, 2014

(54) Self-Adhering Graphics

(71) Applicants: David Cheng, Greenwich, CT (US); Jocelynn Cheng, Greenwich, CT (US)

(72) Inventors: David Cheng, Greenwich, CT (US); Jocelynn Cheng, Greenwich, CT (US)

(21) Appl. No.: 13/614,149

(22) Filed: Sep. 13, 2012

(51) Int. Cl. G09F 3/10

(52) U.S. Cl. 40/638

(57) ABSTRACT

The device described herein includes self-adhering graphics presented in a multiple perspectives so that when applied to structural containers, such as cardboard boxes, the containers are transformed, child playthings.

### BACKGROUND

Structural containers, such as cardboard boxes, are commonly used to ensure safe shipment of materials and products and are constructed in a variety of shapes and sizes. After their primary use is completed, they are commonly disposed of or recycled. The used structural containers can be repurposed into a plaything for children.

### SUMMARY

Generally, this invention relates to utilizing self-adhering graphics (stickers) to modify the aesthetics of structural containers to enable their transformation into imaginative playthings for children. The self-adhering graphics are designed to cover original graphics and logos printed on the outside or inside of the box. The stickers can also decorate a plain box without graphics or logos. This allows for a more complete transformation of the substantially assembled box. “Substantially assembled” as used herein means that the container is not collapsed, but rather open on at least one side granting access while still maintaining a box-like shape. The containers are preferably large enough for a child to substantially fit inside, e.g. an appliance box, storage box, shipping box, or similar.

The sticker is configured to be applied to the exterior or interior panels of a structural container, e.g. a cardboard box. Upon application of one or more stickers, the container is substantially transformed to resemble or embody a vehicle, dwelling or animal. For example, the vehicle or dwelling may be a train, steam engine, construction vehicle, ship, plane, castle, rocket, space ship, etc. The animals represented may be a horse, giraffe, elephant, etc, The large scale of the stickers increases the “playability” of the transformed container making it more life-like.

In one aspect, the invention features a sticker comprising a planar flexible sheet material having an adhesive on one side and a printed play graphic on the opposite side, the sticker having an area of at least 80 in². The sheet material is configured with perforations to allow a user to remove a portion of the sheet material. The perforations could be aligned vertically or horizontally allowing for quick and easy resizing of the device.

In some embodiments, the sheet material could be configured with perforations that outline certain aspects of the play graphic so that they could be removed and placed individually.

In some cases, the adhesive is a repositionable adhesive to allow for reapplication or adjustment of the device.

In some embodiments, the play graphic comprises an outline that can be colored in. Additionally, the device can feature sheet material that would allow user-applied markings to be easily removed.

Some embodiments feature depictions of a vehicle or dwelling. Depictions could feature the interior and exterior aspects of the object.

In another aspect, the invention features a device comprising a plurality of stickers, each sticker comprising a planar flexible sheet material having an adhesive on one side and a printed play graphic on the opposite side. At least two of the stickers are dimensioned to substantially cover an area of at least 150 in², and depict a vehicle or dwelling. In addition, at least one other sticker depicts an object other than the vehicle or dwelling.

In yet a further aspect the device includes, in addition to the sticker(s), an accessory for use in playing with the stickers, the accessory being selected from the group consisting of sound-producing devices, strengthening devices for a box to which the stickers are to be applied, and connecting devices configured to connect two or more boxes.

In another aspect, the device features a plurality of stickers, and the flexible sheet material is provided in the form of a roll, with perforations defining the individual stickers, at least some of the stickers having an area of at least 150 in².

In some aspects, the invention features methods of using the devices described herein. For example, in one aspect the invention features a method of applying a sticker comprising a planar flexible sheet material having an adhesive on one side and a printed play graphic on the opposite side to a box; removing the sticker from the box; and applying the sticker to a surface other than the box. The surface could be, for example, a wall, door, window, etc.

### DESCRIPTION OF THE DRAWINGS

FIG. 1 is a plan view of a sticker.

FIG. 1A is a plan view of an alternate embodiment of the sticker of FIG. 1.

FIG. 2 is a plan view of a second sticker.

FIG. 3 is a three dimensional representation of a structural container.

FIG. 4 is a perspective view of portions of the stickers show in FIGS. 1 and 2 deployed on a structural container.

### DETAILED DESCRIPTION

In preferred embodiments, the devices described herein include sets of self-adhering graphics that show objects such as vehicles, animals, or dwellings from multiple perspectives that, when applied to structural containers, such as cardboard boxes, to transform them into realistic child playthings.

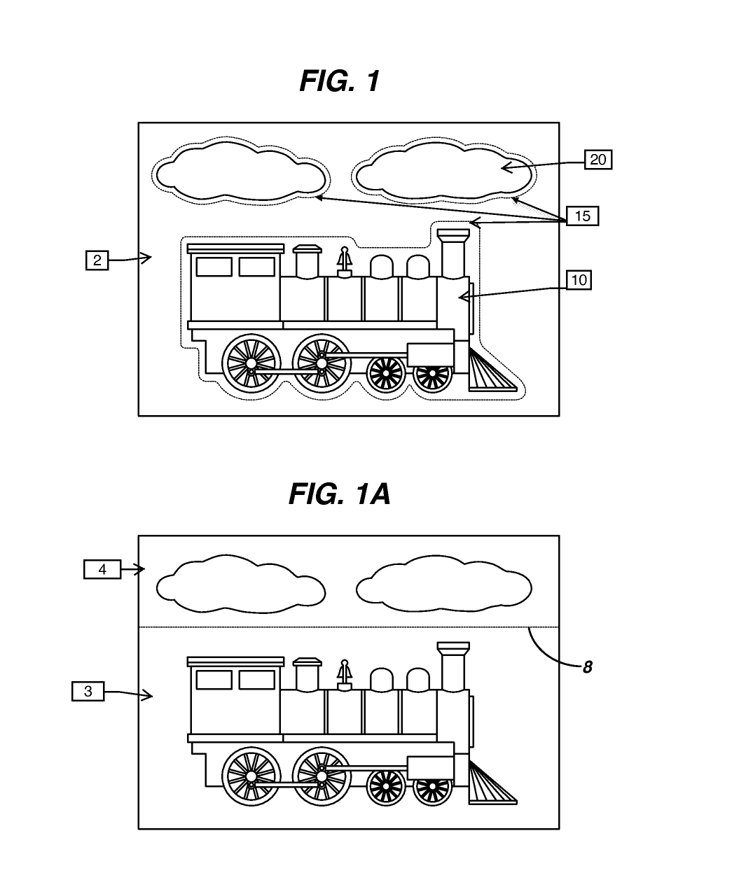

Referring to FIG. 1, a sticker 2 features a self-adhering surface (not shown) that, is covered by a backing, e.g. a release paper film, prior to use. When the backing is removed, the sticker can be placed on a variety of surfaces, such as structural containers. The self-adhering surface can be configured to be removable to enable repositioning and application error correction. The sticker 2 also features a graphic 10, on the opposite surface, that is designed to resemble an object, machine, etc., for example, a steam engine. Multiple views, e.g. front, side, back, etc., of the object are provided as a set of stickers, to enable a more substantial transformation of the structural container 5 (FIG. 3).

The sticker 2 is sized so that a substantial amount of surface area of the structural container 5 is covered. The dimensions of the device 2 are generally at least 8 inches by 10 inches, but could be presented in sizes ranging from 8 inches by 10 inches to 17 inches by 22 inches, with a surface area ranging from 80 square inch to 375 square inch. Generally, four to six separate sheets are used, so as to cover the outer and inner surfaces of a container 5 and in some cases the top of the box as well. This grouping would be sold as a kit.

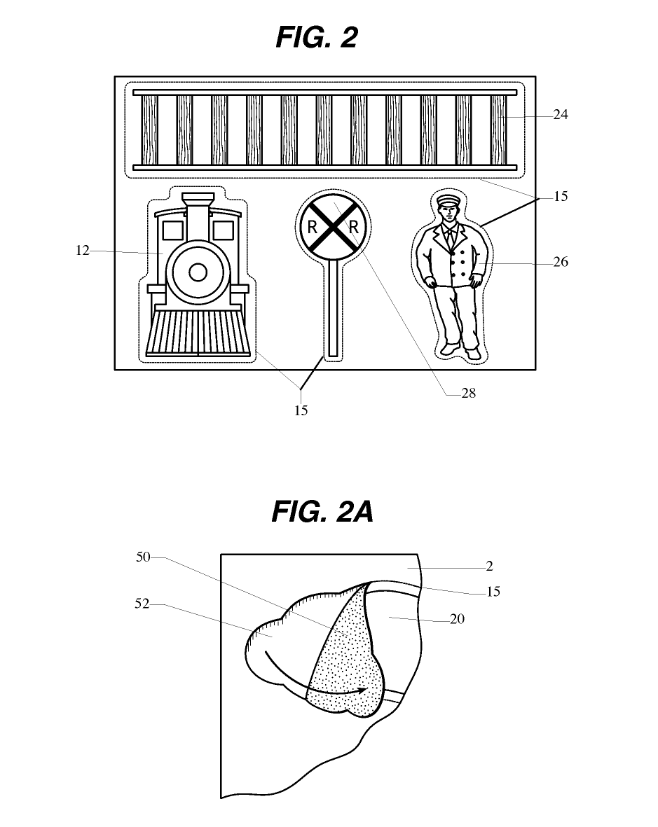

Referring to FIG. 1 and FIG. 2, micro-perforations 15 can be configured to surround the periphery of each individual object allowing them to be removed and placed individually.

Referring to FIG. 1A, one embodiment of the device 2 is configured to include micro-perforations 8 oriented horizontally across the sheet to allow for convenient and rapid size customization of the graphic. Additionally, the micro-perforations 8 could be aligned horizontally or vertically across the picture at different intervals to shorten or diminish the overall size of the graphics while arranged so as to not detract from the overall nature of the graphic. This feature would allow the graphics to be utilized on a larger variety of differently sized containers and enable the user to quickly and conveniently resize the graphic to fulfill their need. In addition, if the stickers 2 were produced in a roll rather than individual planar sheets, vertically oriented micro-perforations would allow for different views of the represented object to be easily separated and applied. In addition, when the stickers 2 are produced in a roll the spacing or orientation of the lines of perforations could be selected to accommodate the size difference between the sides and top of the box.

Referring to FIG. 1 and FIG. 2, in an alternate embodiment micro-perforations 15 surround the primary and secondary graphics, the steam engine 10 and the clouds 20. The micro-perforations 15 provide an easy way to further customize the size of the graphics to better fit on a structural container 5. In this embodiment, the entire sheet can be used as a whole, or one or more of the objects can be used separately.

Referring to FIG. 2, the sheet can include a combination of an image of a vehicle or dwelling (in this case, the front of a train), and other objects, such as a sign and train tracks, as shown.

Referring to FIG. 3, a representation of a structural container 5 is presented without the device 2 applied. The structural container 5 could range in size but is generally large enough for a child to climb into.

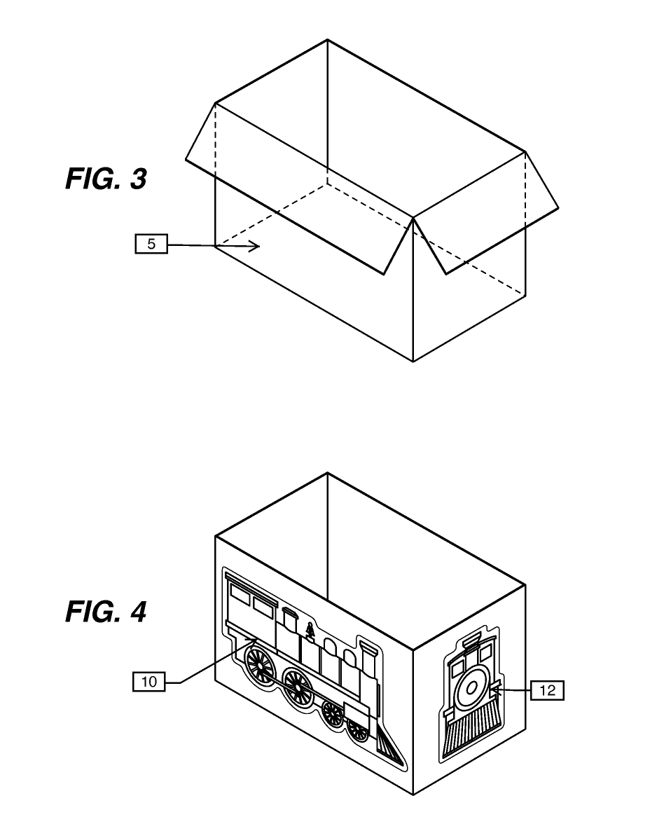

Referring to FIG. 4, a set of stickers is shown applied to multiple surfaces of a structural container 5, representing different stylized views of a locomotive including, but not limited to, a side view 10 and a front view 12. Other views, such as the back or inside could be featured as well. This feature allows the structural container to more completely transform into a realistic plaything.

### OTHER EMBODIMENTS

A number of embodiments have been described. Nevertheless, it will be understood that various modifications may be made without departing from the spirit and scope of the disclosure.

For example, other embodiments could be sized to accommodate a range of structural containers with the intention of covering a majority of the container's surface area.

Other embodiments could feature tactile enhancements that improve the realistic nature of the device. The tactile enhancements could include variations in thickness and textures, such as rubber texture for tires.

In another embodiment, the device could feature unique aromatic characteristics that would be strategically utilized to further enhance the realism of certain aspects of the graphic. For example, the tires of a race car could emit an aromatic characteristic similar to the smell of burnt rubber.

Other embodiments could feature multiple graphics that would comprise a set. Multiple sets could be configured to represent objects typically grouped together, for instance, a steam engine, a coal tender, passenger cars, and a caboose. This grouping, for example, would allow multiple containers to be wholly transformed into the different components typically associated together. Additionally, the set could include accessories such as a rope to connect several boxes so as to mimic a train consisting of multiple cars. Other accessories could include box strengtheners that would prolong the life of the box as a play thing. Further accessories could feature a sound machine that would play pre-recorded sound tracks mimicking sounds typically produced by the object represented by the graphic. Sound tracks could include a whistle, horn, operating sounds, etc.

Another embodiment of the device could be configured to have surfaces that allow for color customization, such as a white background with black outlines, as shown in the figures. This would enable color to be applied with color markers, pencils, paint or similar. Alternatively, the stickers can be partially or fully preprinted in color.

Other embodiments could utilize a variety of self-adhering materials, such as Litho stock, latex, Phototex or vinyl. Utilization of vinyl, or similar, would allow the self-adhering stickers to be reused or reapplied allowing for application error correction. This would ensure easier handling during the application process. Additionally, this feature would allow the sticker to be removed from the box and attached to a wall or similar surface. Litho stock products generally would not have this reapplication feature.

Accordingly, other embodiments are within the scope of the following claims.

1-5. (canceled)

6. A method comprising:
(a) providing a plurality of stickers, each sticker comprising a planar flexible sheet material having an adhesive on one side and a printed play graphic on the opposite side wherein the sheet material includes a horizontal or vertical line of perforations that divides a first portion of the play graphic from a second portion of the play graphic, and the play graphic is configured so that if a user removes the second portion of the play graphic, to reduce the size of the sticker, the first portion of the play graphic depicts a complete image;
wherein at least two of the stickers are dimensioned to substantially cover an area of at least 150 in², and depict at least two sides of a vehicle or dwelling;
(b) removing the second portion of the play graphic of at least one of the stickers to size the sticker to a cardboard box to be used in play; and
(c) placing the stickers on two or more sides of the cardboard box so that they represent the sides of the vehicle or dwelling.

7. The method of claim 6 wherein at least one of the stickers depicts a portion of the interior of the vehicle or dwelling and the method further comprises placing the sticker(s) depicting the interior of the vehicle or dwelling on one or more interior surfaces of the cardboard box.

8-9. (canceled)

10. The method of claim 6 wherein the flexible sheet material is provided in the form of a roll, with perforations defining the individual stickers, and the method further comprises
separating a plurality of the stickers from the roll.

11. The method of claim 6 wherein the play graphic comprises an outline that can be colored in and the method further comprises coloring in at least a portion of the play graphic.

12. The method of claim 11, further comprising wiping the surface of the sheet material clean.

13. The method of claim 6 wherein the adhesive is a repositionable adhesive and the method further comprises removing and repositioning at least one of the stickers.

14-15. (canceled)

16. The method of claim 6 further comprising allowing a child to play inside the box.

17. The method of claim 6 wherein the stickers depict all sides of the dwelling or vehicle.

18. The method of claim 6 wherein the stickers comprise multiple sets of graphics configured to represent a group of vehicles, and the method further comprises applying the stickers to multiple boxes.

19. The method of claim 6 wherein the sticker is configured to cover substantially the entire outer surface of the box.
